(19) United States
(12) Patent Application Publication
(10) Pub. No.: US 2025/0066208 A1
(43) Pub. Date: Feb. 27, 2025

(54) CONDUCTIVE TWO-DIMENSIONAL PARTICLE AND METHOD FOR PRODUCING SAME, CONDUCTIVE FILM, CONDUCTIVE PASTE, AND CONDUCTIVE COMPOSITE MATERIAL

(71) Applicant: Murata Manufacturing Co., Ltd., Nagaokakyo-shi (JP)

(72) Inventor: Hiroki SAKAMOTO, Nagaokakyo-shi (JP)

(21) Appl. No.: 18/943,383

(22) Filed: Nov. 11, 2024

Related U.S. Application Data
(63) Continuation of application No. PCT/JP2023/016244, filed on Apr. 25, 2023.

(30) Foreign Application Priority Data
May 16, 2022 (JP) 2022-080357

(51) Int. Cl. C01B 32/921; C08K 3/14

(52) U.S. Cl. CPC C01B 32/921; C08K 3/14; C01P 2002/72; C01P 2004/20; C01P 2006/40; C08K 2201/001

(57) ABSTRACT

A conductive two-dimensional particle of a layered material, comprising: one or plural layers, wherein the one or plural layers include a layer body represented by: TiₘXₙ, wherein X is a carbon atom, a nitrogen atom, or a combination thereof, n is 1 to 4, and m is more than n and 5 or less, and a modifier or terminal T exists on a surface of the layer body, wherein T is at least one selected from a hydroxyl group, a fluorine atom, a chlorine atom, an oxygen atom, and a hydrogen atom, and an atomic ratio of Al to Ti is 0 atom % to 0.10 atom %.

### CROSS REFERENCE TO RELATED APPLICATIONS

The present application is a continuation of International application No. PCT/JP2023/016244, filed Apr. 25, 2023, which claims priority to Japanese Patent Application No. 2022-080357, filed May 16, 2022, the entire contents of each of which are incorporated herein by reference.

### TECHNICAL FIELD

The present disclosure relates to a conductive two-dimensional particle and a method for producing same, a conductive film, a conductive paste, and a conductive composite material.

### BACKGROUND ART

In recent years, MXene has been attracting attention as a new material having conductivity. MXene is a type of so-called two-dimensional material, and as will be described later, is a layered material in the form of one or plural layers. In general, MXene is in the form of particles (which can include powders, flakes, nanosheets, and the like) of such a layered material.

Currently, various studies are being conducted toward the application of MXene to various electrical devices. For example, Non-patent Document 1 discloses that in view of the fact that a large amount of two-dimensional titanium carbide MXene has hardly been produced, two-dimensional titanium carbide MXene is synthesized by changing the amount of reaction at one time, and whether or not this affects the structure and composition of two-dimensional titanium carbide MXene flakes when a large amount of two-dimensional titanium carbide MXene is produced is confirmed using a scanning electron microscope, X-ray diffraction, dynamic light scattering, Raman spectroscopy, X-ray photoelectron spectroscopy, ultraviolet-visible spectroscopy, conductivity measurement, and the like. In addition, Non-patent Document 2 discloses that an MXene antenna formed of two-dimensional (2D) titanium carbide (MXene) has a small reflectance and can ensure conductivity and water dispersibility as a material useful for producing a thin, lightweight, and flexible antenna.
Non-patent Document 1: Scalable Synthesis of Ti3C2Tx MXene, Christopher E. Shuck et al., ADVANCED ENGINEERING MATERIALS 2020
Non-patent Document 2: 2D Titanium carbide (MXene) for wireless communication, SCIENCE ADVANCES, 21 Sep. 2018, Vol 4, Issue 9

### SUMMARY OF THE DISCLOSURE

However, it is hard to say that the MXene antennas and the like disclosed in Non-patent Document 1 and Non-patent Document 2 have high conductivity, and it seems that improvement is necessary to realize a conductive film having higher conductivity. The present disclosure has been made in view of the above circumstances, and an object thereof is to provide a conductive two-dimensional particle capable of forming a conductive film having high conductivity and the like, a method for producing the conductive two-dimensional particle, and a conductive film, a conductive paste, and a conductive composite material, using the conductive two-dimensional particle.

According to one aspect of the present disclosure, there is provided a conductive two-dimensional particle of a layered material, including: one or plural layers, wherein the one or plural layers include a layer body represented by: TiₘXₙ, wherein X is a carbon atom, a nitrogen atom, or a combination thereof, n is 1 to 4, and m is more than n and 5 or less, and a modifier or terminal T exists on a surface of the layer body, wherein T is at least one selected from a hydroxyl group, a fluorine atom, a chlorine atom, an oxygen atom, and a hydrogen atom, and an atomic ratio (Al/Ti) of Al to Ti is 0 atom % to 0.10 atom %.

According to another aspect of the present disclosure, there is provided a method for producing a conductive two-dimensional particle, the method including: (a) preparing a precursor represented by: TiₘAlXₙ, wherein X is a carbon atom, a nitrogen atom, or a combination thereof, n is 1 to 4, and m is more than n and 5 or less; (b1) removing at least a part of the Al from the precursor by bringing the precursor into contact with an etching solution to obtain an etched product; (c) washing the etched product with water to obtain a washed product; (d) stirring a mixed solution containing the washed product and a compound for interlayer insertion of the washed product to obtain an intercalated product; and (e1) delaminating the intercalated product to obtain a conductive two-dimensional particle, wherein an atomic ratio (Al/Ti) of Al to Ti in the conductive two-dimensional particle is 0 atom % to 0.10 atom %.

According to the present disclosure, there is provided a conductive two-dimensional particle which is formed of a predetermined layered material (also referred to as “MXene” in the present specification), and having an atomic ratio (Al/Ti) of Al to Ti of 0 atom % to 0.10 atom %. With this, the conductive two-dimensional particle contains MXene, is capable of forming a conductive film exhibiting high conductivity.

Furthermore, according to the present disclosure, it is possible to a produce conductive two-dimensional particle having an atomic ratio (Al/Ti) of Al to Ti is 0 atom % to 0.10 atom % by (a) preparing a predetermined precursor, (b1) removing at least a part of Al from the precursor by bringing the precursor into contact with an etching solution to product an etched product, (c) washing the etched product with water to obtain a washed product, (d) stirring a mixed solution containing the washed product and a compound for interlayer insertion of the washed product, and (e1) delaminating the intercalated product.

### BRIEF DESCRIPTION OF THE DRAWINGS

FIGS. 1(a) and 1(b) are schematic cross-sectional views illustrating MXene which is a layered material usable for a conductive film in one embodiment of the present embodiment, in which FIG. 1(a) illustrates single-layer MXene, and FIG. 1(b) illustrates multilayer (exemplarily two-layered) MXene.

FIGS. 2(a) and 2(b) are diagrams illustrating a conductive film in one embodiment of the present disclosure, in which FIG. 2(a) illustrates a schematic cross-sectional view of the conductive film, and FIG. 2(b) illustrates a schematic perspective view of MXene particles in the conductive film.

FIG. 3 is a view illustrating XRD measurement results of precipitates (AlF₃·3H₂O) in Examples.

### DETAILED DESCRIPTION

### Embodiment 1: Conductive Two-Dimensional Particle

Hereinafter, a conductive two-dimensional particle in one embodiment of the present disclosure will be described in detail, but the present disclosure is not limited to such an embodiment.

The conductive two-dimensional particle in the present embodiment is a conductive two-dimensional particle of a layered material, includes one or plural layers, wherein the one or plural layers include a layer body represented by a formula below:

TiₘXₙ
wherein X is a carbon atom, a nitrogen atom, or a combination thereof,
   n is 1 to 4, and
   m is more than n and 5 or less, and
a modifier or terminal T exists on a surface of the layer body, wherein Tis at least one selected from the group consisting of a hydroxyl group, a fluorine atom, a chlorine atom, an oxygen atom, and a hydrogen atom, and
an atomic ratio (Al/Ti) of Al to Ti is 0 atom % to 0.10 atom %.

The layered material can be understood as a layered compound and is also denoted by “TiₘXₙTₛ”, in which s is an optional number, and in the related art, x or z may be used instead of s. Typically, n can be 1, 2, 3, or 4, but is not limited thereto.

MXenes whose above formula TiₘXₙ is expressed as below are known, such as, Ti₂C, Ti₂N, Ti₃C₂, Ti₃N₂, Ti₃(CN), Ti₄N₃.

For example, the MAX phase is Ti₃AlC₂ and MXene is Ti₃C₂Tₛ (in other words, X is C, n is 2, and m is 3).

It is noted, in the present disclosure, MXene may contain remaining Al at a relatively small amount, for example, at 6% by mass or less with respect to the original amount of Al. The remaining amount of Al can be preferably 5% by mass or less. However, even if the residual amount of Al exceeds 6% by mass, there may be no problem depending on the application and use conditions of the conductive two-dimensional particle.

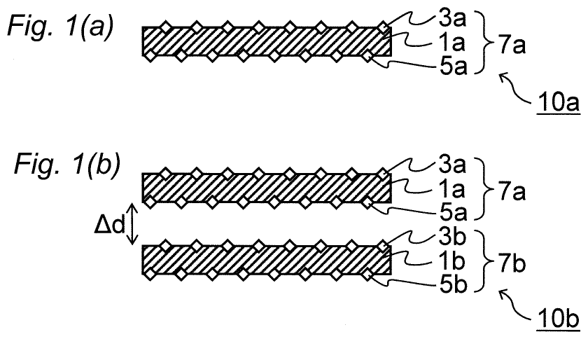

The conductive two-dimensional particle of the present embodiment is an aggregate containing one layer of MXene 10a (single-layer MXene) schematically illustrated in FIG. 1(a). More specifically, the MXene 10a is MXene layer 7a having layer bodies (TiₘXₙ layers) 1a represented by TiₘXₙ, and modifiers or terminals T3a, 5a existing on the surfaces of the layer bodies 1a (more specifically, on at least one of both surfaces, facing each other, of each layer). Therefore, the MXene layers 7a is also represented by “TiₘXₙTₛ”, wherein s is any number.

The conductive two-dimensional particle of the present embodiment may include one layer and plural layers. Examples of the MXene (multilayer MXene) of the plural layers include, but are not limited to, two layers of MXene 10b as schematically illustrated in FIGS. 1(b). 1b, 3b, 5b, and 7b in FIG. 1(b) are the same as 1a, 3a, 5a, and 7a in FIG. 1(a) described above. In the case of the multilayer MXene, two adjacent MXene layers (for example, 7a and 7b) may not necessarily be completely separated from each other, but may be partially in contact with each other. The MXene 10a is ones in which multilayer MXene 10b is individually separated and exists as one layer.

As a result of remaining an unseparated multilayer MXene 10b, a mixture of the single-layer MXene 10a and the multilayer MXene 10b may exist.

Although the present embodiment is not limited, the thickness of each layer of MXene (which corresponds to the MXene layers 7a and 7b) is, for example, 0.8 nm to 10 nm, further 0.8 nm to 5 nm, particularly 0.8 nm to 3 nm (which may mainly vary depending on the number of Ti layers included in each layer). For the individual laminates of the multilayer MXene that can be included, the interlayer distance (alternatively, a void dimension which is indicated by Ad in FIG. 1(b)) is, for example, 0.8 nm to 10 nm, particularly 0.8 nm to 5 nm, and more particularly about 1 nm, and the total number of layers can be 2 to 20,000.

In the conductive two-dimensional particle of the present embodiment, the multilayer MXene that can be included may be MXene having a few layers obtained through the delamination treatment. The term “having a few layers” means that, for example, the number of stacked layers of MXene may be 10 layers or less, and may be 6 layers or less. Hereinafter, the “multilayer MXene having a few layers” may be referred to as a “few-layer MXene” in some cases. In addition, the single-layer MXene and the few-layer MXene may be collectively referred to as “single-layer/few-layer MXene” in some cases.

The conductive two-dimensional particle of the present embodiment preferably contains a single-layer MXene and a few-layer MXene, that is, a single-layer/few-layer MXene. In the conductive two-dimensional particle, the ratio of the single-layer/few-layer MXene may be 50% by volume or more, or the ratio of the multilayer MXene may be 50% by volume or more. Preferably, the ratio of the single-layer/few-layer MXene is 50% by volume or more. In the conductive two-dimensional particle of the present embodiment, the ratio of the single-layer/few-layer MXene having a thickness of 10 nm or less is more preferably 90% by volume or more, and still more preferably 95% by volume or more in terms of the ratio to the total MXene.

It is preferable that the conductive two-dimensional particles have a large volume ratio of the single-layer/few-layer MXene, and an average value of thicknesses of the conductive two-dimensional particles is 15 nm or less. The average value of the thicknesses is more preferably 10 nm or less. On the other hand, the lower limit of the average value of the thicknesses of the conductive two-dimensional particles may be 0.5 nm.

The average value of the thicknesses of the conductive two-dimensional particles is determined as a number average dimension (for example, a number average of at least 40 particles) based on an atomic force microscope (AFM) photograph.

The conductive two-dimensional particle of the present embodiment is an MXene two-dimensional particle having a low Al concentration in which the atomic ratio (Al/Ti) of Al to Ti is 0 atom % to 0.10 atom %. That is, Al may not be contained, and even when Al is contained, Al is suppressed within the range of the atomic ratio. In the conductive two-dimensional particles of the present embodiment, Al is sufficiently removed by controlling etching conditions, for example, as described later, in etching of the MAX phase as a precursor, and the MXene two-dimensional particles obtained through the subsequent steps have a sufficiently low atomic ratio (Al/Ti) of Al to Ti. The atomic ratio (Al/Ti) of Al to Ti is determined by analyzing the contents of Al and Ti by ICP emission spectrometry as shown in Examples described later.

### Embodiment 2: Method for Producing Conductive Two-Dimensional Particle

Hereinafter, a method for producing a conductive two-dimensional particle in the embodiment of the present disclosure will be described in detail, but the present disclosure is not limited to such an embodiment.

A method for producing a conductive two-dimensional particle of the present embodiment (first producing method), the method includes
(a) preparing a precursor represented by a formula below:

TiₘAlXₙ
wherein X is a carbon atom, a nitrogen atom, or a combination thereof,
   n is 1 to 4, and
   m is more than n and 5 or less;
(b1) removing at least a part of the Al from the precursor by bringing the precursor into contact with an etching solution to obtain an etched product;
(c) washing the etched product with water to obtain a washed product;
(d) stirring a mixed solution containing the washed product and a compound for interlayer insertion of the washed product to obtain an intercalated product; and
(e1) delaminating the intercalated product to obtain a conductive two-dimensional particle,
wherein an atomic ratio (Al/Ti) of Al to Ti in the conductive two-dimensional particle is 0 atom % to 0.10 atom %.

Another method for producing a conductive two-dimensional particle (second producing method) of the present embodiment includes
(a) preparing a precursor represented by a formula below:

TiₘAlXₙ
wherein X is a carbon atom, a nitrogen atom, or a combination thereof,
   n is 1 to 4, and
   m is more than n and 5 or less, and
(b2) removing at least a part of the Al from the precursor by bringing the precursor into contact with an etching solution containing a compound for interlayer insertion to produce an etched and intercalated product; and
(e2) delaminating the etched and intercalated product to obtain a conductive two-dimensional particle,
wherein an atomic ratio (Al/Ti) of Al to Ti in the conductive two-dimensional particle is 0 atom % to 0.10 atom %.

Hereinafter, each step of the first producing method and the second producing method will be described in detail.

### Step (a)

In both the first producing method and the second producing method, first, a predetermined precursor is prepared. A predetermined precursor that can be used in the present embodiment is a MAX phase that is a precursor of MXene, and is represented by a formula below:

TiₘAlXₙ
wherein X is a carbon atom, a nitrogen atom, or a combination thereof,
   n is 1 to 4, and
   m is more than n and 5 or less.

The above X, n, and m are as described in MXene.

The MAX phase has a crystal structure in which a layer constituted by Al is located between two layers represented by TiₘXₙ (each X may have a crystal lattice located in an octahedral array of Ti). When typically m=n+1, but not limited thereto, the MAX phase includes repeating units in which each one layer of X atoms is disposed in between adjacent layers of n+1 layers of Ti (these are also collectively referred to as a “TiₘXₙ layer”), and a layer of Al (“Al layer”) is disposed as a layer next to the (n+1)th layer of Ti.

The MAX phase can be produced by a known method. For example, a TiC powder, a Ti powder, and an Al powder are mixed in a ball mill, and the obtained mixed powder is calcined under an Ar atmosphere to obtain a calcined body (block-shaped MAX phase). Thereafter, the calcined body obtained is pulverized by an end mill to obtain a powdery MAX phase for the next step.

### Step (b1)

In the first producing method, etching is performed to remove at least a part of Al from the precursor by bringing the precursor into contact with the etching solution. The etching conditions are not limited as long as the atomic ratio (Al/Ti) of Al to Ti in the finally obtained conductive two-dimensional particles is 0 atom % to 0.10 atom %. Preferably, an etching solution containing HF is used. HF may be mixed with another acid as an auxiliary acid. Examples of other acids include hydrochloric acid, phosphoric acid, and hydroiodic acid. For example, pure water may be mixed as a solvent. The etching solution preferably contains HF and has a HF concentration of 7.0 M or more. The HF concentration is more preferably 8.0 M or more. The upper limit of the HF concentration may be, for example, 30 M. From the viewpoint of performing etching in a short time to increase the yield of conductive two-dimensional particles, it is preferable to increase the HF concentration of the etching solution.

The time for contact with the etching solution (hereinafter, referred to as “etching time”) is preferably 8 hours or less. By shortening the etching time to preferably 8 hours or less, formation of mainly insulating AlF₃·3H₂O as Al impurities in MXene can be suppressed, and MXene two-dimensional particles suitable for formation of a film having high conductivity can be obtained. The etching time is more preferably 6 hours or less. On the other hand, from the viewpoint of sufficiently removing Al from the MAX phase, the etching time is preferably, for example, 0.5 hours or more.

Examples of the method for bringing the precursor into contact with the etching solution include immersing the precursor in the etching solution. Other preferable conditions for the etching treatment are not particularly limited, and known conditions can be adopted. Examples of the etched product obtained by the etching treatment include slurry.

### Step (c)

In the first producing method, the etched product obtained by the etching is washed. By performing washing, the acid and the like used in the etching can be sufficiently removed. Note that it has been separately confirmed that even if the above-described etching conditions are not appropriate and Al impurities are formed as deposits during etching, the deposits are not sufficiently removed by this washing. A washing medium to be mixed with the etched product is not limited as long as the acid and the like can be sufficiently removed. For example, in addition to water (pure water), washing may be performed with a solution containing a substance other than water, such as dilute hydrochloric acid. The amount of washing medium and the washing method are not particularly limited. For example, stirring with added water, centrifugation, and the like may be performed. Examples of the stirring method include stirring using a handshake, an automatic shaker, a share mixer, a pot mill, or the like. The degree of stirring such as stirring speed and stirring time may be adjusted according to the amount, concentration, and the like of the object to be treated. The washing may be performed one or more times. Preferably, washing is performed multiple times. For example, specifically, steps (i) to (iv) of (i) adding washing medium (to the etched product or the remaining precipitate obtained in the following (iv)), (ii) stirring, and (iii) centrifuging the stirred product, and (iv) discarding the supernatant after centrifugation and recovering the remaining precipitate are performed within a range of 2 times or more, for example, 15 times or less.

### Step (d)

In the first producing method, the intercalation treatment of the compound for interlayer insertion is performed including stirring a mixed solution containing the washed product and a compound for insertion between layers of the washed product (simply referred to compound for interlayer insertion).

The compound for interlayer insertion is not limited to specific type as long as it is a compound that can be inserted between the layers of the washed product and can be separated into the respective layers by the delamination in the next step (e1). The compound for interlayer insertion is preferably an alkali metal compound or an alkaline earth metal compound. A Li-containing compound is more preferable. As the Li-containing compound, an ionic compound in which a Li ion and a cation are bonded can be used. Examples thereof include a chloride of Li, a phosphate of Li, a sulfate of Li, a nitrate of Li, and a carboxylate of Li. LiCl, which is a chloride of Li, is preferable.

Other conditions of the intercalation treatment are not particularly limited. The liquid property of the mixed solution containing the washed product and the compound for interlayer insertion of the washed product is not limited. The mixed solution containing the washed product and the compound for interlayer insertion of the washed product is preferably acidic, for example, with a pH of 6 or less.

The content of the compound for interlayer insertion in the intercalation formulation is preferably 0.001% by mass or more. The content is more preferably 0.01% by mass or more, and still more preferably 0.1% by mass or more. On the other hand, from the viewpoint of dispersibility in a solution, the content of the compound for interlayer insertion is preferably 10% by mass or less, and more preferably 1% by mass or less.

The specific method of intercalation is not particularly limited, and for example, the compound for interlayer insertion may be mixed with a moisture medium clay of MXene which is a water-treated product and stirred, or may be allowed to stand. For example, stirring at room temperature can be mentioned. Examples of the stirring method include a method using a stirring bar such as a stirrer, a method using a stirring blade, a method using a mixer, and a method using a centrifugal device. The stirring time can be set according to the producing scale of the conductive two-dimensional particle, and may be, for example, set to 12 to 24 hours.

### Step (b2)

In the second producing method, etching of removing (removing and optionally layer separation) at least a part of Al from the precursor is performed by bringing the precursor into contact with an etching solution containing a compound for interlayer insertion, and an intercalation treatment on the compound for interlayer insertion is performed.

In the present embodiment, an intercalation treatment of inserting a compound for interlayer insertion containing, for example, Li or the like between layers of the TiₘXₙ layer (which may include a case where a part of Al remains) is performed at the time of etching (removing and optionally layer separation) at least a part of Al from the MAX phase. As the compound for interlayer insertion, the same compound as the compound for interlayer insertion described in the step (b1) can be used. Lithium fluoride may be used as the compound for interlayer insertion.

The content of the compound for interlayer insertion in the etching solution is preferably 0.001% by mass or more. The content is more preferably 0.01% by mass or more, and still more preferably 0.1% by mass or more. On the other hand, from the viewpoint of dispersibility in a solution, the content of the compound for interlayer insertion in the etching solution is preferably 10% by mass or less, and more preferably 1% by mass or less.

The etching solution in the step (b2) is not limited as long as the etching solution contains the compound for interlayer insertion, and the atomic ratio (Al/Ti) of Al to Ti in the finally obtained conductive two-dimensional particles is 0 atom % to 0.10 atom %. Preferably, an etching solution containing HF is used. More preferably, as described in the step (b1), the precursor is brought into contact with an etching solution having a HF concentration of 7.0 M or more for 8 hours or less. Other preferable conditions are not limited, and examples thereof include a method using a mixed solution of lithium fluoride and hydrochloric acid. Examples of these methods include a method using a mixed solution with pure water as a solvent. Examples of the etched product obtained by the etching treatment include slurry.

Among the first producing method and the second producing method, the first producing method is preferable since it more easily forms MXene into a single layer by separating the step (b1) of etching treatment and the step (c) of intercalation treatment.

Step (e1), Step (e2)

In the first producing method, the intercalated product obtained by the intercalation treatment is used, and in the second producing method, the (etched and intercalated) product obtained by performing the etching and the intercalation treatment is used, and delamination is performed to obtain conductive two-dimensional particles in which the atomic ratio (Al/Ti) of Al to Ti in the particles is 0 atom % to 0.10 atom %. The conditions for delamination treatment are not particularly limited, and delamination can be performed by a known method. Examples of the method include the following method.

For example, it is possible to perform a delamination treatment including a step of centrifuging the intercalated product and washing the remaining precipitate with water after discarding the supernatant. For example, the step includes that a slurry-like intercalated product or a (etched and intercalated) product is centrifuged to discard the supernatant, and then the remaining precipitate is washed with water or a solution containing a substance other than water as a washing medium. Examples of the step include (i) the washing medium is added to the remaining precipitate after discarding the supernatant, and the mixture is stirred, (ii) centrifuged, and (iii) the supernatant is recovered. This operation of (i) to (iii) is repeated 1 time or more, preferably 2 times to 10 times to obtain a conductive two-dimensional particle as a delaminated product. Alternatively, the supernatant may be centrifuged, and the supernatant after centrifugation may be discarded to obtain a conductive two-dimensional particle as a delaminated product.

In the producing method of the present embodiment, an ultrasonic treatment is not performed as delamination after etching. As described above, since the ultrasonic treatment is not performed, particle breakage hardly occurs, and it is possible to obtain a conductive two-dimensional particle including single-layer/few-layer MXene having a large two-dimensional surface. The conductive two-dimensional particle containing single-layer/few-layer MXene having a large two-dimensional surface can form a film without using a binder, and the obtained film exhibits high conductivity.

### Embodiment 3: Conductive film

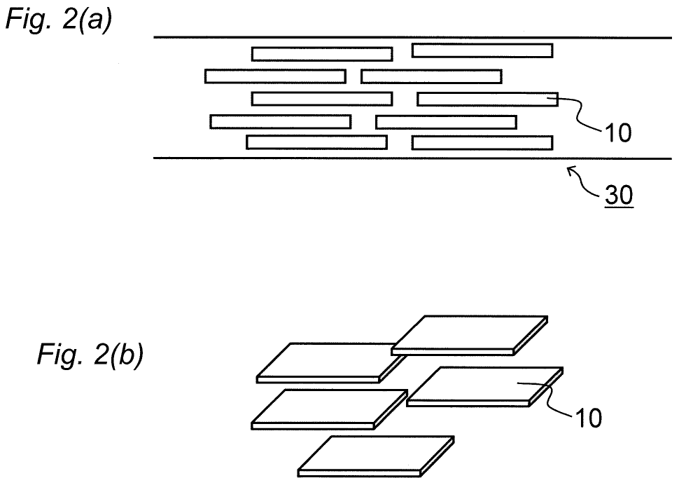

Examples of the conductive film of the present embodiment include a conductive film containing conductive two-dimensional particles of the present embodiment. Referring to FIG. 2, a conductive film 30 of the present embodiment includes conductive two-dimensional particles 10 of a predetermined layered material as illustrated in FIG. 2(a). FIG. 2(b) is a schematic perspective view of MXene particles contained in the conductive film 30. The conductive film of the present embodiment may be a film obtained by stacking only the conductive two-dimensional particles 10.

The conductive film may be a conductive composite material film further containing a polymer (resin). The polymer may be contained, for example, as an additive such as a binder added at the time of film formation, or may be added for providing strength or flexibility. In a case of the conductive composite material film, the proportion of the polymer in the conductive composite material film (when dried) may be more than 0% by volume and preferably 30% by volume or less. The proportion of the polymer may be further 10% by volume or less, and further 5% by volume or less. In other words, the proportion of the conductive two-dimensional particles (particles of the layered material) in the conductive composite material film (when dried) is preferably 70% by volume or more, more preferably 90% by volume or more, and still more preferably 95% by volume or more. The conductive film may be a stacked film of two or more conductive composite material films having different proportions of the conductive two-dimensional particles.

Examples of the polymer include hydrophilic polymers (the hydrophilic polymers include a hydrophobic polymer with a hydrophilic auxiliary that exhibits hydrophilic property, and a hydrophobic polymer or the like having a surface treated to make it hydrophilic). The hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, and nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, and nylon are preferably used.

Among these, one or more polymers selected from the group consisting of water-soluble polyurethane, polyvinyl alcohol, and sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

The film thickness of the conductive film is preferably 0.5 μm to 20 μm. By increasing the film thickness of the conductive film, the contact resistance of the grain boundary is reduced, and the conductivity tends to be increased, and thus the film thickness is preferably 0.5 μm or more. The film thickness is more preferably 1.0 μm or more. The film thickness is preferably as large as possible from the viewpoint of conductivity, but when flexibility or the like is required, the film thickness is preferably 20 μm or less, and more preferably 15 μm or less. The thickness of the conductive film can be measured by, for example, measurement with a micrometer, cross-sectional observation by a method such as a scanning electron microscope (SEM), a microscope, or a laser microscope.

In the conductive film formed of the conductive two-dimensional particle of the present embodiment, the conductivity obtained by substituting the thickness of the conductive film measured by the method described above, for example, the thickness of the conductive film measured by the method described in Examples, and the surface resistivity of the conductive film into the following formula can preferably achieve 7,000 S/cm or more.

Conductivity [S/cm]=1/(thickness [cm] of conductive film×surface resistivity [Ω/□] of conductive film)

### Method for Producing Conductive Film

A method for producing a conductive film of the present embodiment using MXene particles (conductive two-dimensional particle) produced as described above is not particularly limited. For example, as exemplified below, a conductive film can be formed.

First, an MXene dispersion in which the MXene particles prepared as described above are present in a medium liquid is prepared. Examples of the medium liquid include an aqueous medium liquid and an organic medium liquid. The medium liquid of the MXene dispersion is typically water, and in some cases, other liquid substances may be contained in a relatively small amount (for example, 30% by mass or less, and preferably 20% by mass or less based on the whole mass) in addition to water.

Before drying, a precursor of a conductive film (also referred to as a “precursor film”) may be formed using the MXene dispersion. The method for forming the precursor film is not particularly limited, and for example, suction filtration, coating, spray, or the like can be used.

More specifically, as the MXene dispersion, for example, a supernatant containing conductive two-dimensional particles is appropriately adjusted (for example, diluted with an aqueous medium liquid), and is subjected to suction filtration through a filter (which may constitute a predetermined member together with the conductive film, or may be finally separated from the conductive film) installed in a nutsche or the like. Thereby, the aqueous medium liquid is at least partially removed, so that a precursor film can be formed on the filter. The filter is not particularly limited, but a membrane filter or the like can be used. By performing the suction filtration, a conductive film can be produced without using the binder or the like. When the conductive two-dimensional particles of the present embodiment are used, a conductive film can be produced without using a binder or the like as described above.

Alternatively, the MXene dispersion may be applied to the substrate as it is or after being appropriately adjusted (for example, dilution with an aqueous medium liquid, or addition of a binder). Examples of the coating method include a method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating method, a dip coating method, or a dropping method. As a substrate, for example, a substrate formed of a metal material, a resin, or the like suitable for the biosignal sensing electrode can be appropriately adopted as the substrate. By coating onto any suitable substrate (which may constitute a predetermined member together with the conductive film, or may be finally separated from the conductive film), a precursor film can be formed on the substrate.

Next, the precursor film formed as described above is dried to obtain, for example, a conductive film 30 as schematically illustrated in FIG. 2. In the present disclosure, the “drying” means removing the aqueous medium liquid that can exist in the precursor.

Drying may be performed under mild conditions such as natural drying (typically, it is disposed in an air atmosphere at normal temperature and normal pressure) or air drying (blowing air), or may be performed under relatively active conditions such as hot air drying (blowing heated air), heat drying, and/or vacuum drying. The drying may be performed, for example, at a temperature of 400° C. or lower using a normal pressure oven or a vacuum oven.

The forming and drying the precursor film may be appropriately repeated until a desired conductive film thickness is obtained. For example, a combination of spraying and drying may be repeated a plurality of times.

When the conductive composite material of the present embodiment has a sheet-like form, for example, as illustrated below, the conductive two-dimensional particles and the polymer can be mixed to form a coating film.

First, the MXene dispersion or the MXene powder in which the conductive two-dimensional particles (MXene particles) are present in a medium liquid (aqueous medium liquid or organic medium liquid) may be mixed with a polymer. The medium liquid of the MXene dispersion is typically water, and in some cases, other liquid substances may be contained in a relatively small amount (for example, 30% by mass or less, and preferably 20% by mass or less based on the whole mass) in addition to water.

The stirring of the conductive two-dimensional particles (MXene particles) and the polymer can be performed using a dispersing device such as a homogenizer, a propeller stirrer, a thin film swirling stirrer, a planetary mixer, a mechanical shaker, or a vortex mixer.

A slurry which is a mixture of the MXene particles and the polymer may be applied to a substrate (for example, a substrate), but the application method is not limited. Examples of the coating method include a method in which spray coating is performed using a nozzle such as a one-fluid nozzle, a two-fluid nozzle, or an air brush, a slit coating method using a table coater, a comma coater, or a bar coater, a screen printing method, a metal mask printing method, a spin coating method, a dip coating method, or a dropping method. As described above, a substrate formed of a metal material, a resin, or the like suitable for the biosignal sensing electrode can be appropriately adopted as the substrate.

The coating and drying may be repeated a plurality of times as necessary until a film having a desired thickness is obtained. The drying and curing may be performed, for example, at a temperature of 400° C. or lower using a normal pressure oven or a vacuum oven.

### Embodiment 4: Conductive Paste

Examples of other applications of using the conductive two-dimensional particles of the present embodiment include a conductive paste containing the conductive two-dimensional particles. Examples of the conductive paste include a mixture of conductive two-dimensional particles (particles of a predetermined layered material) and a medium. Examples of the medium include an aqueous medium liquid, an organic medium liquid, a polymer, metal particles, and ceramic particles, and examples thereof include those containing one or more of these. The mass ratio of the conductive two-dimensional particles (particles of the layered material) in the conductive paste is, for example, 50% or more.

Examples of the application include forming a conductive film by applying the conductive paste onto a substrate or the like and drying the paste.

### Embodiment 5: Conductive Composite Material

Examples of other applications of using the conductive two-dimensional particles of the present embodiment include a conductive composite material containing the conductive two-dimensional particles and a polymer. The conductive composite material is not limited to the shape of the conductive composite material film described above. The shape of the conductive composite material may be a shape having thickness, a rectangular parallelepiped, a sphere, a polygon, or the like, other than the film shape.

As the polymer, a polymer similar to the polymer used for the conductive composite material film can be used. For example, it may be contained as an additive such as a binder added at the time of film formation, or may be added for providing strength or flexibility. The proportion of the polymer in the conductive composite material (when dried) may be more than 0% by volume and preferably 30% by volume or less. The proportion of the polymer may be further 10% by volume or less, and further 5% by volume or less. In other words, the proportion of the particles of the layered material in the conductive composite material (when dried) is preferably 70% by volume or more, more preferably 90% by volume or more, and still more preferably 95% by volume or more.

Examples of the polymer include a hydrophilic polymer (the hydrophilic polymers include a hydrophobic polymer with a hydrophilic auxiliary that exhibits hydrophilic property, and a hydrophobic polymer or the like having a surface treated to make it hydrophilic), The hydrophilic polymer more preferably includes one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, and nylon.

Examples of the hydrophilic polymer include a hydrophilic polymer having a polar group, and those in which the polar group is a group that forms a hydrogen bond with a modifier or terminal T of the layer are more preferable. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, and nylon are preferably used.

Among these, one or more polymers selected from the group consisting of water-soluble polyurethane, polyvinyl alcohol, and sodium alginate are more preferable. As the polymer, a polymer having a urethane bond having both the hydrogen bond donor property and the hydrogen bond acceptor property is preferable, and from this viewpoint, the water-soluble polyurethane is particularly preferable.

Although the conductive two-dimensional particle, the method for producing the conductive two-dimensional particle, the conductive film, the conductive paste, and the conductive composite material in the embodiments of the present disclosure have been described in detail above, various modifications are possible. It should be noted that the conductive two-dimensional particle according to the present embodiment may be produced by a method different from the producing method in the above-described embodiment, and the method for producing a conductive two-dimensional particle of the present embodiment is not limited only to one that provides the conductive two-dimensional particle according to the above-described embodiment.

### EXAMPLES

### Production of Single-Layer/Few-Layer MXene

### Examples 1 to 3 and Comparative Examples 1 to 3

In Examples 1 to 4, steps of (1) preparation of the precursor (MAX), (2) etching of the precursor, (3) washing after etching, (4) Li intercalation, and (5) delamination described below in detail were performed in this order to prepare a single-layer/few-layer MXene-containing sample.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The calcined body (block-shaped MAX) thus obtained was pulverized with an end mill to a maximum dimension of 40 μm or less. In this way, Ti₃AlC₂ particles were obtained as a precursor (powdery MAX).

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### Etching Conditions

Precursor: Ti₃AlC₂ (sieving with a mesh size of 45 μm)
Etching solution composition: HF concentration is as shown in Table 1 below.
HCl concentration: 7.4 M
Etching solution amount: 60 mL
Amount of precursor (Ti₃AlC₂) input: 3.0 g
Etching container: 100 mL Aiboy
Etching temperature: 35° C.
Etching time: as shown in Table 1 below
Stirrer rotation speed: 400 rpm

### (3) Washing After Etching

The slurry was divided into two portions, each of which was inserted into two 50 mL centrifuge tubes, centrifuged under the condition of 3500 G using a centrifuge, and then the supernatant was discarded. An operation of adding 40 mL of pure water to the remaining precipitate in each centrifuge tube, centrifuging again at 3500 G, and separating and removing the supernatant was repeated 11 times. After final centrifugation, the supernatant was discarded to obtain a Ti₃C₂Tₛ-moisture medium clay. In the present embodiment, the washing is performed with pure water, but the present disclosure is not limited thereto, and the washing may be performed with dilute hydrochloric acid or the like, for example.

### (4) Li Intercalation

Li intercalation was performed on the Ti₃C₂Tₛ-moisture medium clay prepared by the above method.

### Conditions of Li Intercalation

Ti₃C₂Tₛ-moisture medium clay (MXene after washing): solid content 0.75 g
LiCl: 0.75 g
Intercalation container: 100 mL Aiboy
Temperature: 20° C. or higher and 25° C. or lower (room temperature)
Time: 18 h
Stirrer rotation speed: 800 rpm

### (5) Delamination

The slurry obtained by Li intercalation was charged into a 50 mL centrifuge tube, centrifuged under the condition of 3500 G using a centrifuge, and then the supernatant was discarded. Next, (i) 40 mL of pure water was added to the remaining precipitate, and the mixture was stirred for 15 minutes with a shaker, then (ii) centrifuged at 3500 G, and (iii) the supernatant was recovered as a single-layer/few-layer MXene-containing liquid. The operations (i) to (iii) were repeated 4 times in total to obtain a single-layer/few-layer MXene-containing supernatant. Further, this supernatant was centrifuged under the conditions of 4500 G and 2 hours using a centrifuge, and then the supernatant was discarded to obtain a single-layer/few-layer MXene-containing clay.

TABLE 1

| | Etching solution | | | Film |
|---|---|---|---|---|
| | HF concentration | Etching time | Al/Ti | conductivity |
| | (M) | (hr) | (at %) | (S/cm) |
| Comparative | 2.8 | 24 | 0.134 | 6982 |
| Example 1 | | | | |
| Comparative | 5.6 | 24 | 0.142 | 6569 |
| Example 2 | | | | |
| Comparative | 9.9 | 24 | 0.180 | 5565 |
| Example 3 | | | | |
| Example 1 | 7.6 | 6 | 0.096 | 7687 |
| Example 2 | 8.0 | 6 | 0.083 | 7665 |
| Example 3 | 9.9 | 6 | 0.042 | 7688 |

### Evaluation

### Atomic Ratio (Al/Ti) of Al to Ti

The single-layer/few-layer MXene-containing samples (single-layer/few-layer MXene-containing clays) obtained in Examples 1 to 3 and Comparative Examples 1 to 3 were freeze-dried to prepare a powder, and the powder was dissolved by an alkali melting method. The contents of Al and Ti were analyzed by ICP emission spectrometry to determine the atomic ratio of Al to Ti. For the above analysis, iCAP6300 manufactured by Thermo Fisher Scientific Inc. was used. The results are also shown in Table 1.

### Conductivity of Film

### Method for Producing Film

The single-layer/few-layer MXene-containing clay (solid content: 0.0375 g) obtained by delamination and 25 mL of pure water were mixed to form a slurry, and the slurry was subjected to suction filtration to prepare an MXene film (MXene film). As a filter for suction filtration, a membrane filter (Durapore, manufactured by Merck KGaA, pore size 0.65 μm) was used. After the filtration, vacuum drying was performed at 80° C. for 8 hours or more to obtain an MXene film.

### Method for Measuring Film Density

The film was punched into a disk shape having a diameter of 12 mm with a punch, the weight was measured with an electronic balance, and the thickness was measured with a height gauge. Then, the film density was calculated from these measured values.

### Method for Measuring Film Conductivity

The conductivity of the obtained MXene film was determined. For the conductivity, the resistivity ((2) and the thickness (μm) were measured at three points per sample, the conductivity (S/cm) was calculated from these measured values, and the average value of three conductivities obtained by this calculation was adopted. The surface resistance of the film was measured by a 4-terminal method using a simple low resistivity meter Loresta-AX MCP-T370 (manufactured by Mitsubishi Chemical Analytech Co., Ltd.). Then, the volume resistivity was determined from the obtained surface resistance and film thickness measured with a micrometer, and the conductivity was determined by taking the reciprocal of the value. The conductivity is a value obtained by normalizing the film density to 2 g/cm³. The results are also shown in Table 1.

The following can be said from Table 1 above. In Examples 1 to 3, etching was performed in a time in which the HF concentration of the etching solution was relatively high and was shorter than in the conventional case, thereby obtaining an MXene film. The obtained MXene film was a conductive film in which Al/Ti was suppressed to 0.10 atom % or less and which exhibited a high conductivity of 7,000 S/cm or more. On the other hand, in Comparative Examples 1 to 3, etching was performed by a conventional method, that is, under the condition that the HF concentration of the etching solution was various and the etching time was as long as 24 hours to obtain an MXene film. In the obtained MXene film, Al/Ti was more than 0.10 atom %, and the conductivity was less than 7,000 S/cm. Although the present embodiment is not bound by any theory, the reason why the MXene film of Examples 1 to 3 exhibited a higher conductivity than the MXene film of Comparative Examples 1 to 3 is considered as follows. That is, when the etching time is long, AlF₃·3H₂O is precipitated during etching, and since this AlF₃·3H₂O is insoluble in water, it is considered that the AlF₃·3H₂O cannot be reduced even by washing with pure water or the like, and remains on the surface, between layers, or the like of MXene. As a result, it is considered that the conductivity of the MXene film decreases due to the presence of AlF₃ which is an insulator contained in MXene. On the other hand, in Examples 1 to 3, it is considered that AlF₃, the insulator, was reduced and the conductivity of the film was improved by using an etching solution containing HF at a certain concentration or more and shortening the etching time to a time equal to or less than a certain value. It has been separately confirmed that AlF₃ is a trihydrate, but the presence or absence of hydrated water and the number of hydrated water are not limited.

The following Experiment 1 and Experiment 2 for verifying the above Examples were also performed.

### Experiment 1

In 60 mL of an etching solution (HF: 2.8 M, HCl: 7.4 M), 0.42 g of pure aluminum powder was put and dissolved, and then left for various leaving times shown in the following Table 2, and thereafter, the amount of precipitates precipitated in the etching solution was determined. The results are also shown in Table 2.

TABLE 2

| Leaving time (hr) | Precipitated amount (g) |
|---|---|
| 5 | 0.0049 |
| 24 | 1.6054 |
| 48 | 1.6432 |

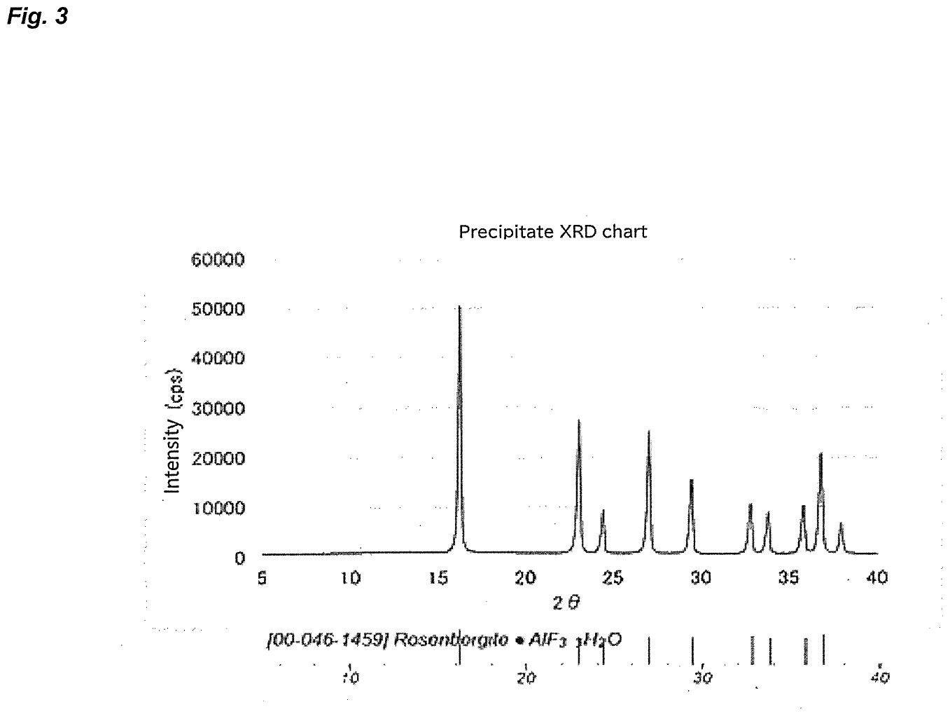

In addition, the XRD measurement of the precipitate was performed under the following conditions. As a result of the measurement, an XRD profile is illustrated in FIG. 3. From FIG. 3, it was confirmed that the precipitate was AlF₃·3H₂O.

### XRD Measurement Conditions

Apparatus used: MiniFlex 600 manufactured by Rigaku Corporation
Measurement conditions
Light source: Cu tube bulb
Characteristics X-ray: CuKα=1.54 Å
Measurement range: 3 degrees to 20 degrees
Step: 50 steps/degree

From the results of Table 2 and XRD measurement, it was confirmed that the longer the etching time corresponding to the standing time, the larger the amount of AlF₃·3H₂O that can be precipitated as a precipitate.

### Experiment 2

Etching was performed for an etching time of 1, 3, or 6 hours using etching solutions (same as etching solution used in Examples except for HF) having different HF concentrations. Then, an etching rate was obtained for the obtained etched product. The etching rate was determined by performing water washing after the etching, and then performing analysis by ICP emission spectrometry to determine the Al amount (atom %). Then, it is assumed that Al to be detected is derived from Ti₃AlC₂, and the etching rate (%) was obtained from [(Al constituting Ti₃AlC₂−detected Al)/(Al constituting Ti₃AlC₂)]×100 (atomic ratio). The results are shown in Table 3.

TABLE 3

Etching rate (%)

| Etching time | HF concentration of | HF concentration of |
|---|---|---|
| (hr) | etching solution: 2.8M | etching solution: 9.9M |
| 1 | 10.8 | 50.0 |
| 3 | 22.0 | 77.3 |
| 6 | 32.1 | 89.3 |

From the results in Table 3, it is considered that when the HF concentration of the etching solution is as low as 2.8 M, the etching rate is only 32.1% even when the etching time is 6 hours, and the yield of MXene particles obtained by further performing intercalation or the like after etching is low in the first place. Therefore, it is considered that it is difficult to shorten the etching time when the HF concentration of the etching solution is low. On the other hand, when the HF concentration of the etching solution was 9.9 M, the etching time was 6 hours and the etching rate was 89.3%, and it was found that the etching can be performed in a short time, and the etching time can be shortened. In addition, if the etching time is short, the precipitation amount of AlF₃·3H₂O is small, and most of the detected Al amount is considered to be derived from Ti₃AlC₂.

The conductive two-dimensional particle, the conductive film, the conductive paste, and the conductive composite material of the present disclosure can be used in any suitable application, and can be preferably used, for example, as electrodes or the like in electrical devices.

The disclosure content of the present specification may include the following aspects.
<1> A conductive two-dimensional particle of a layered material, comprising: one or plural layers, wherein the one or plural layers include a layer body represented by a formula below: TiₘXₙ, wherein X is a carbon atom, a nitrogen atom, or a combination thereof, n is 1 to 4, and m is more than n and 5 or less, and a modifier or terminal T existing on a surface of the layer body, wherein T is at least one selected from the group consisting of a hydroxyl group, a fluorine atom, a chlorine atom, an oxygen atom, and a hydrogen atom, and an atomic ratio (Al/Ti) of Al to Ti is 0 atom % to 0.10 atom %.
<2> The conductive two-dimensional particle according to <1>, wherein an average value of thicknesses of the conductive two-dimensional particles is 15 nm or less.
<3> The conductive two-dimensional particle according to <1> or <2>, wherein the TiₘXₙ is Ti₃C₂.
<4> A method for producing a conductive two-dimensional particle, the method comprising: (a) preparing a precursor represented by: TiₘAlXₙ, wherein X is a carbon atom, a nitrogen atom, or a combination thereof, n is 1 to 4, and m is more than n and 5 or less; (b1) performing etching of removing at least a part of Al from the precursor by bringing the precursor into contact with an etching solution; (c) washing an etched product obtained by etching with water to obtain a washed product; (d) performing an intercalation treatment of a compound for interlayer insertion, the intercalation treatment including stirring a mixed solution containing the washed product and the compound for interlayer insertion of the washed product; and (e1) performing delamination using an intercalated product obtained by the intercalation treatment to obtain a conductive two-dimensional particle, wherein an atomic ratio (Al/Ti) of Al to Ti in the conductive two-dimensional particle is 0 atom % to 0.10 atom %.
<5> A method for producing a conductive two-dimensional particle, the method comprising: (a) preparing a precursor represented by: TiₘAlXₙ, wherein X is a carbon atom, a nitrogen atom, or a combination thereof, n is 1 to 4, and m is more than n and 5 or less; (b2) performing etching of removing at least a part of Al from the precursor by bringing the precursor into contact with an etching solution containing a compound for interlayer insertion, and performing an intercalation treatment on the compound for interlayer insertion; and (e2) performing delamination using an (etched and intercalated) product obtained by performing etching and the intercalation treatment to obtain a conductive two-dimensional particle, wherein an atomic ratio (Al/Ti) of Al to Ti in the conductive two-dimensional particle is 0 atom % to 0.10 atom %.
<6> The method for producing a conductive two-dimensional particle according to <4> or <5>, wherein the etching solution has a HF concentration of 7.0 M or more, and a time for bringing the precursor into contact with the etching solution is 8 hours or less.
<7> The method for producing a conductive two-dimensional particle according to any one of <4> to <6>, wherein a time for bringing the precursor into contact with the etching solution is 0.5 hours or more.
<8> The method for producing a conductive two-dimensional particle according to any one of <4> to <7>, wherein the TiₘAlXₙ is Ti₃AlC₂.
<9> A conductive film comprising the conductive two-dimensional particle according to any one of <1> to <3>.
<10> The conductive film according to <9>, wherein the conductive film is formed of the conductive two-dimensional particle, and a conductivity of the conductive film is 7,000 S/cm or more, where the conductivity [S/cm]=1/(thickness [cm] of conductive film×surface resistivity [Ω/□] of conductive film).
<11> A conductive paste comprising the conductive two-dimensional particle according to any one of <1> to <3>.
<12> A conductive composite material comprising the conductive two-dimensional particle according to any one of <1> to <3> and a polymer.

This application claims priority based on Japanese Patent Application No. 2022-080357. Japanese Patent Application No. 2022-080357 is incorporated herein by reference.

### REFERENCE SIGNS LIST

1a, 1b Layer body (MₘXₙ layer)
3a, 5a, 3b, 5b Modifier or terminal T
7a, 7b MXene layer
10, 10a, 10b MXene particles (conductive two-dimensional particle, particles of layered material)
30 Conductive film

1. A conductive two-dimensional particle of a layered material, comprising:
one or plural layers, wherein the one or plural layers include a layer body represented by:
TiₘXₙ
wherein X is a carbon atom, a nitrogen atom, or a combination thereof,
n is 1 to 4, and
m is more than n and 5 or less, and
a modifier or terminal T exists on a surface of the layer body, wherein Tis at least one selected from a hydroxyl group, a fluorine atom, a chlorine atom, an oxygen atom, and a hydrogen atom, and
an atomic ratio of Al to Ti is 0 atom % to 0.10 atom %.

2. The conductive two-dimensional particle according to claim 1, wherein an average value of thicknesses of the conductive two-dimensional particles is 15 nm or less.

3. The conductive two-dimensional particle according to claim 1, wherein the TiₘXₙ is Ti₃C₂.

4. A method for producing a conductive two-dimensional particle, the method comprising:
preparing a precursor represented by:
TiₘAlXₙ
wherein X is a carbon atom, a nitrogen atom, or a combination thereof,
n is 1 to 4, and
m is more than n and 5 or less;
removing at least a part of the Al from the precursor by bringing the precursor into contact with an etching solution to obtain an etched product;
washing the etched product with water to obtain a washed product;
stirring a mixed solution containing the washed product and a compound for interlayer insertion of the washed product to obtain an intercalated product; and
delaminating the intercalated product to obtain the conductive two-dimensional particle,
wherein an atomic ratio of Al to Ti in the conductive two-dimensional particle is 0 atom % to 0.10 atom %.

5. The method for producing a conductive two-dimensional particle according to claim 4, wherein the etching solution has a HF concentration of 7.0 M or more, and a time for bringing the precursor into contact with the etching solution is 8 hours or less.

6. The method for producing a conductive two-dimensional particle according to claim 4, wherein a time for bringing the precursor into contact with the etching solution is 0.5 hours or more.

7. The method for producing a conductive two-dimensional particle according to claim 4, wherein the TiₘAlXₙ is Ti₃AlC₂.

8. A method for producing a conductive two-dimensional particle, the method comprising:
preparing a precursor represented by:
TiₘAlXₙ
wherein X is a carbon atom, a nitrogen atom, or a combination thereof,
n is 1 to 4, and
m is more than n and 5 or less;
removing at least a part of the Al from the precursor by bringing the precursor into contact with an etching solution containing a compound for interlayer insertion so as to perform an intercalation treatment on the compound for interlayer insertion to obtain an etched and intercalated product; and
delaminating the etched and intercalated product to obtain a conductive two-dimensional particle,
wherein an atomic ratio of Al to Ti in the conductive two-dimensional particle is 0 atom % to 0.10 atom %.

9. The method for producing a conductive two-dimensional particle according to claim 8, wherein the etching solution has a HF concentration of 7.0 M or more, and a time for bringing the precursor into contact with the etching solution is 8 hours or less.

10. The method for producing a conductive two-dimensional particle according to claim 8, wherein a time for bringing the precursor into contact with the etching solution is 0.5 hours or more.

11. The method for producing a conductive two-dimensional particle according to claim 8, wherein the TiₘAlXₙ is Ti₃AlC₂.

12. A conductive film comprising the conductive two-dimensional particle according to claim 1.

13. The conductive film according to claim 12, wherein the conductive film is formed of the conductive two-dimensional particle, and a conductivity of the conductive film is 7,000 S/cm or more, where the conductivity [S/cm]=1/(thickness [cm] of conductive film×surface resistivity [Ω/□] of conductive film).

14. A conductive paste comprising the conductive two-dimensional particle according to claim 1.

15. A conductive composite material comprising the conductive two-dimensional particle according to claim 1 and a polymer.

16. The conductive composite material according to claim 15, wherein a proportion of the conductive two-dimensional particle is 70% by volume or more.

17. The conductive composite material according to claim 15, wherein the polymer is hydrophilic.
